(19) United States
(12) Patent Application Publication
(10) Pub. No.: US 2025/0001510 A1
(43) Pub. Date: Jan. 2, 2025

(54) POSITION-DEPENDENT SEGMENT CONTROL OF THE WELDING PARAMETERS

(71) Applicant: Strunk Connect automated solutions GmbH & Co. KG, Kirchen (DE)

(72) Inventors: Olaf STRUNK, Kirchen-Freusburg (DE); Uwe KEIL, Hückeswagen (DE)

(73) Assignee: Strunk Connect automated solutions GmbH & Co. KG, Kirchen (DE)

(21) Appl. No.: 18/710,098

(22) PCT Filed: Nov. 8, 2022
(86) PCT No.: PCT/EP2022/081044

§ 371 Date: May 14, 2024

(30) Foreign Application Priority Data
Nov. 15, 2021 (DE) 10 2021 129 735.4

(51) Int. Cl. B23K 1/00; B23K 11/00; B23K 20/02; B23K 103/18

(52) U.S. Cl. CPC B23K 1/0008; B23K 11/002; B23K 20/02; B23K 2103/18

(57) ABSTRACT

A method for producing a hot-crimp connection includes the following metallurgically different steps that are run through sequentially: Segment 1: Producing a first connection between the shaped part and the outer layer of the wires and/or stranded wires by a complete and/or partial eutectic melting process of the outer wires which have been freed by the concurrently proceeding compaction and/or predeformation of an insulating layer, Segment 2: Producing a diffusion bond and/or an at least partial fusion bond between the inner wires of the strand which have been freed from the insulating layer by the compaction, Segment 3: Currentless cooling of the hot-crimped bond, a switchover taking place between at least two successive segments after a segment-specific height position has been reached and/or energy/charge has been fed in.

### CROSS-REFERENCE TO RELATED APPLICATION

This application is a national stage application, filed under 35 U.S.C. § 371, of International Patent Application PCT/EP2022/081044, filed on Nov. 8, 2022, which claims the benefit of German Patent Application DE 10 2021 129 735.4, filed on Nov. 15, 2021.

### BACKGROUND

The disclosure relates to a method for producing a hot-crimp connection between a shaped part and at least one wire and/or at least one strand with at least two wires made of metals, wherein a materially bonded connection is produced both between the connecting components and between the wires of the strand with simultaneous compaction and deformation.

### SUMMARY

Evaluation of the control parameters common today:

Resistance curve: The curve is calculated from the quotient of the measured voltage and the measured current. Since a direct measurement of the voltage in the connection zone is not technically feasible, the measured voltage values are falsified by the contact resistances of the components and electrodes and by the material resistances of the components and electrodes. However, a rough orientation is possible.

Current and voltage curve: The problem is the same as with the resistance measurement.

Temperature curve: Temperature can only be measured externally. The temperature of the connection zone cannot be directly monitored. The measuring point is usually too large and equally captures both the component and the electrode. With optical systems, the correction factor is difficult to determine and is not constant. Thermocouples measure the electrode temperature in the region of the cooling zone.

Pressing force curve: An additional measured value for monitoring the pressing force curve.

Sinking path: Resetting of the electrode effected by the connection process. Since this records the complete distance, it provides no information about the course of the movement over time.

Final end height: Monitoring the customer specification. If the initial height is not recorded, the measured values do not provide any information about the actual total sinking path.

The object of the disclosure is to produce electrical connections between electrical conductors and an electrical terminal which are stable in the long term while precluding fluctuations in quality as far as possible, while avoiding the disadvantages described, and which can also be produced quickly and inexpensively.

The object is achieved by the method steps as disclosed herein.

### BRIEF DESCRIPTION OF THE DRAWINGS

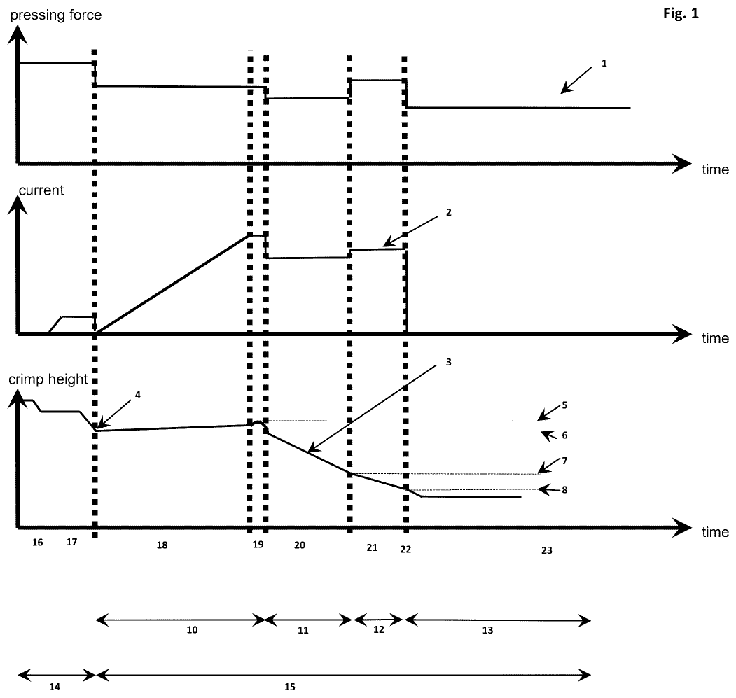

The invention is explained in more detail with the aid of a drawing (FIG. 1). The drawing shows an example of the course of a hot-crimp process according to the invention.

### DETAILED DESCRIPTION

FIG. 1 shows an exemplary possible curve of a hot-crimp process (15) with a predeformation or a pre-crimp phase (14) taking place immediately beforehand. The latter consists of one phase of cold crimping (16) and one of hot crimping (17). The hot-crimp phase (15) is made up of the steps segment 1 (10), segment 2a (11), segment 2b (12) and segment 3 (13).

The segment 1 (10) starts with recording the starting height 4 and ends when the height drops below the switchover height segment 1 (6). The energy input in the segment 1 (10) can be concluded from the difference in height between the heat expansion stroke (5) and the starting height of the hot crimp (4). This initial energy leads to the first establishment of a connection (step a) in the segment 1 (10). The current curve (2) is divided into a ramped current curve during the heating (18) and possibly a constant current curve during, in this case, the hard soldering (19). This first establishment of the connection can begin without restriction as early as in the heating phase (18) and end in the segment 2 (11 or 12). The temperature development in the connection zone depends significantly on the force curve (1), the current curve (2), the starting height (4), the heat input in the pre-crimp phase (14), the position of the switchover heights (6+7+8), and the duration.

Upon achieving the first establishment of a connection in the segment 1 (10), energy continues to be supplied, although at a different level. Upon reaching the switchover heights (7+8), here in the segments 2a+b (20+21), the current (2) and the force (1) are adjusted to meet the requirements for producing a diffusion bond and/or partial fusion bond.

Upon dropping below a final switchover height in the segment 2, here (8), the current is switched off (22) and the cooling (23) begins in the segment 3 (13) combined with a further drop in the crimp height (resetting of the electrodes).

The curve of the crimp height (3) over time in each segment is essentially determined by the position of the switchover heights (here 6, 7, 8), by the current (2), by the pressing force (1), and by the preheating in the preceding segments.

The claimed method divides the materially bonded connection process into several segments with different metallurgical effects and different sets of parameters. The point at which the switch-off height falls below a specified level is used as the switchover criterion for each segment. If a safe switchover is not possible because the electrode has not sunk low enough in a given segment, the switch-off can also be triggered by exceeding a defined time period.

Since the pressing force should be switchable from segment to segment, no current flow is preferably provided for the duration of the settling process of the force regulator. In the event of a force undershoot this prevents the electrodes and/or components from overheating due to insufficient pressing force.

During this short pause, however, there is usually further compaction of the stranded wires combined with uncontrolled sinking of the electrodes. The predetermined switch-off height of each segment, rather than the sinking path during energization, can thus be used as the switchover criterion for a segment.

The method described here can be applied to a plurality of metals, such as copper, aluminum, iron, titanium, nickel, etc., and their alloys, either alone or combined.

The most important welding parameters are the current, the pressing force and the duration. These main parameters are influenced by the dimensions of the components to be connected and of the electrodes, as well as by the material properties of the components, the electrodes, and the coating (type and thickness).

The cooling and the power source must also be taken into account. For the current source, AC/DC, phase control, pulse width or, analogously, the current direction, and the control type (constant current, constant voltage, or constant power) all play a role.

Hot crimping combines a mechanical and a physical process: These are the reshaping and the connection.

In general, cold crimping is understood here as a mechanical deformation, which possibly may be supported by a current flow (then warm crimp), between at least one shaped part and a strand. This is also referred to here as prepressing or predeforming or precrimping.

Hot crimp is understood here to mean at least a two-stage connection process with simultaneous mechanical deformation of at least two connection partners (shaped part and strand).

In principle, hot crimping involves connecting the wire(s) and/or the typically round or profiled wires of a strand(s) to a shaped part, such as a cable lug, sleeve, strap, plug connector, or butt connector in such a way that a permanent mechanical and metallurgical, materially bonded connection between these components can be achieved. This process can be roughly divided into two steps:

a prepressing or predeformation for creating a defined and enlarged electrode contact surface, and the actual hot crimping. The latter can be further subdivided into complete or partial melting of a solder, wherein hard solder with the property of a diffusion barrier is preferred over soft solder. However, the connection partners, e.g., a copper component without coating, can also be used directly with the aluminum wires of the strand with subsequent diffusion with possibly partial melting of the stranded wires. In the latter case, the wires of the strand connect with one another.

At the same time, the compacting process removes the insulating layers both during prepressing and during the hot-crimp process. In a known manner, these insulating layers can be oxide layers, varnish layers, insulating layers, or contamination layers. The coating or the solder can be applied galvanically (with or without current flow), physically (sputtering), as a shaped insert part, or using rolling technology.

Studies have shown that, in addition to the pressing force and current of each segment, the achievable sinking path of each segment is decisive for the welding quality.

In contrast to the typical setting parameters for the segment, current, pressing force, and duration, a parameter set consisting of current, pressing force and switch-off height is proposed here. It has been shown that due to the plurality of influencing variables, time control cannot achieve a sufficiently reliable and reproducible hot-crimp process.

The energy or charge fed into each segment can be used as an additional or alternative criterion for the switchover to the next segment.

Different variants of the hot crimp are proposed:

In the one-shot variant, the prepressing and the actual hot crimping are carried out in one arrangement without removing the components in between, while two arrangements are used for the two-shot variant.

Two-shot: A first arrangement is used for prepressing and a second for hot crimping. During the prepressing, a precrimp is carried out using a cold crimp (compaction without current) and/or with the support of a low pre-heating current, with the aim of achieving a defined precrimp height and/or a defined electrode contact surface. However, when using only a cold crimp, the cold crimp height is essentially determined by the pressing force and the material properties and thus, in practice, is not as practical for higher quality. An additional height switch-off can produce an improvement.

It is thus preferable to follow the cold crimp process directly with a height-monitored warm crimp. In this way, the defined precrimp height is achieved and, in the same step, a sufficiently comparable contact surface for the electrodes.

The components preformed and affixed to one another in this way, the strand with the shaped part, are now connected to each other in a materially bonded manner in the subsequent hot-crimp step.

This step is also divided into several segments.

In the first segment, the energy required for the eutectic fusion bond between the outer wires of the strand and the shaped part is introduced. The most important setting parameters are the pressing force, the current, and the switch-off height as well as energy/charge.

After exceeding a maximum expansion and subsequently dropping below a switchover height and/or energy/charge specifically defined for the segment 1, there is a switchover to the segment 2.

After achieving a first establishment of a connection in the connection zone of the outermost wires of the strand bundle with the shaped part in segment 1, the diffusion bond and/or the at least partial melting of the wires of the strand with each other takes place in the second segment and possibly further sub-segments. Here too, the parameters pressing force, current, and switch-off height and/or energy/charge are defined separately for each segment.

Once the last switching threshold has been reached, the current is switched off and cooling is initiated with the newly adjusted pressing force.

This multi-stage process control can prevent, for example, the lower-melting strand from melting in an impermissible quantity and thus weakening the durability of the entire connection by changing the alloy and reducing the cross section.

An important quality criterion for weld quality monitoring can be the measured expansion of the shaped part and the strand as a result of the thermal expansion caused by the applied current and the recorded duration of energization or the introduced energy/charge of each individual segment.

With the one-shot variant, the prepressing and hot crimping processes are combined into one overall process.

In a further embodiment, the precrimp phase can be integrated into the heating phase of the segment 1.

The resistance curve, the current or voltage curve, the temperature curve, the pressing force curve, the sinking path, or the final end height are usually used for non-destructive monitoring of the connection process.

Destructive tests in accordance with DIN or customer specifications can be carried out within the batch.

The aim of the monitoring is to ensure a long-term stable and materially bonded connection between the components/welding partners.

For welding tasks, such as hot crimping, for example, it has proven useful according to the invention to divide the welding sequence into several segments, usually with different parameter sets. This accounts better for the different metallurgical transformations during the connecting process and provides additional measured values for evaluating the quality of the welded connection.

This connection method is characterized in that, the division of the connection process into a plurality of segments takes place with optimal process parameters for each segment. The quality monitoring can take the form of monitoring the heat equalization stroke, the actual duration of the individual segments, and/or the sinking speed, and/or the fed-in energy/charge or current duration of each segment.

The measurement data and the setting variables of each individual component are stored in the database. The individual labeling is carried out in a known manner by applying a data code, such as a barcode, data matrix code, etc., to one of the components. Limited traceability can be achieved by using lot cards and time stamps.

What is essential is that this multi-stage connection technology makes it possible to produce a materially bonded and mechanically strong connection between same or different metallic materials. In particular, a two-stage method can be used to connect materials which have melting points that differ widely from one another. If the method described here is not used, there is a risk that the low-melting material will melt before a connection can be formed between the connecting partners.

At present, the current strength and time must always be set separately when determining the parameters, and the effect on the deformation and thus the sinking path over time must be determined in trials. In addition, fluctuations in the electricity grid are to be expected during hot crimping due to the high current requirements, which make it more difficult to determine parameters during the definition phase and to ensure stable production quality during the production phase.

One solution to these problems is the height-dependent and/or input energy/charge-dependent switching of the individually optimized segments of a hot crimp. For each segment, the duration is adapted to the component-specific situation through the switchover mechanism. In this way, fluctuations in material properties, dimensions, power supply, electrode wear, etc., are compensated for individually for each component.

In combination, this means a very high level of production quality and the possibility of traceability and process optimization. Batch fluctuations and/or arrangement instabilities can thus be recorded, automatically evaluated, and interventions automatically initiated in a simple manner.

The physical properties of the materials, including the electrodes, determine the temperature curve of the self-heating during the three steps a,b,c. Higher-resistance materials, such as tungsten, lead to greater self-heating than low-resistance materials, such as copper.

Thermal conductivity also influences the heat flow from the contact zone to the cooling. Specific weight and specific heat capacity also change the heating behavior of the electrodes according to the equation for adiabatic heating.

When considering the adiabatic temperature increase=current\hat{ }2/surface\hat{ }2*spec. resistance/spec. weight/spec. heat capacity*time period, it also follows that the surface of the contact zone, and the contour (flat, concave, or convex) of the contact zone also play an important role in determining the electrodes in addition to the choice of material.

Following the idea of the invention, an application-specific optimization of the dimensions and the materials is proposed here in order to control the heat flow in the shaped part and in the strand in the required manner.

If, for example, an application requires greater heat development on the lower electrode, for example, this lower electrode is preferably made of a higher-resistance material and/or with a comparatively smaller contact surface than the opposite upper electrode. This occurs with shaped parts where the strand must be heated more on the lower contact zone on the “strap” side than on the upper contact zone on the “strand” side. A change in current or duration only leads to equal electrode heating on both sides.

When producing a long-term stable and materially bonded connection between a shaped part and a strand, the process is divided into a plurality of steps. This is important because the heat development in the connection zone of the shaped part with the outer wire ring of the strand and within the strand composite is controlled in such a way that the melting temperature of the aluminum, for example, is only partially reached. A complete melting, as occurs during the aptly-named resistance welding, would lead to the following sources of error:

The compaction pressure generated by the crimp process, which pressure is necessary to destroy the non-conductive layers on the wires (oxide layer and/or varnish layer), cannot be built up. On the contrary, it leads to the melted strand material (e.g., aluminum) being squeezed out, so that as a consequence, the contact surfaces between the stranded wires are inadequately formed. In addition, the heat generation does not result primarily from the current flow through the strand (self-heating) but from the current flowing through the electrodes and the shaped part.

After the outer wires are connected to the sleeve, with increasing deformation and the resulting increase in the contact area between the wires the oxide layer and insulating layer are removed by pressure and temperature, and only enough energy is supplied to keep the strand at diffusion temperature. If an increased melting of the stranded wires were to occur in this step, it would lead to an impermissible melt leakage and an insufficient bonding of the wires to one another.

To generate the melt, first the Joule heat is required to reach the melting temperature, and then the melting heat is required. In addition, the heat lost via electrodes and components must be supplied. Typically, the melting heat is higher than the Joule heat by a factor of nine.

In contrast, a diffusion bonding requires a high pressing force, a high temperature, but below the melting temperature, and a long duration.

To prevent increased melt formation, the overall process is divided into a plurality of steps, and possibly into substeps, in order to create a solid diffusion bond and not a fusion bond within the strand, with a high pressing force and the longest possible duration at the same time. Different current settings or current flow durations or sinking speeds have proven effective for each of the segments. Switchover between the segments can preferably be height-controlled and/or dependent on the energy/charge fed in.

The fact that the heat required to generate a melt is approx. 9 times greater than the Joule heating is helpful in ensuring the diffusion process rather than a fusion process.

A partial, often selectively localized melting between the wires occurs because during deformation, some of the wires have a point-by-point contact (asperides) with one another and these small surfaces develop a very high temperature.

The first connection between the shaped part and the stranded wires is created by a eutectic melting between the strand material and the shaped part. As both materials can be coated individually or on both sides, the following combinations are possible, among many others:
Bare copper shaped part with bare aluminum strand
Coated copper shaped part with bare aluminum strand
Coated copper shaped part with coated aluminum strand
Bare copper shaped part with coated aluminum strand

For the coating, the known soft solder materials tin and zinc are available and as hard solders the aluminum hard solder materials according to DIN or eutectic solders with the preferred properties of a diffusion barrier, such as nickel or silver. The materials for the coating vary with the component materials. The important thing is the eutectic temperature.

A key requirement for this hot crimp connection technology is that the connection partners have a eutectic melting temperature below the melting temperature of the strand material. For example, copper with aluminum has a eutectic melting temperature of approx. 550° C., silver with aluminum of approx. 570° C. (if copper was coated with silver) and nickel with aluminum of approx. 640° C. (if copper was coated with nickel).

In contrast to resistance welded connections, the inventive idea is aimed at a two-stage process sequence with firstly a eutectic fusion bond (step a) between the strand and the shaped part and a second connection establishment of a connection (step b) diffusion process between the stranded wires.

An overlap of the steps (a and b) can naturally occur since the spatial extension of the contacting and connecting zone will result in different local heating.

An optimum sinking speed can be specified for each segment. During the process, a sinking speed is continuously calculated within each segment from the sinking path and the required time. This trajectory is compared with the target trajectory and the current is readjusted using control technology algorithms. Upon dropping below the switchover height and/or reaching the preselected energy/charge of this segment, the system switches over to the next segment.

1.-16. (canceled)

17. A method for producing a hot-crimp connection between a shaped part and a strand with at least two wires made of metals, wherein a materially bonded connection is produced both between connecting components and between the wires of the strand with simultaneous compaction and deformation, wherein the following metallurgically different steps are run through sequentially:
a) segment 1: producing a first connection between the shaped part and an outer layer of the strand by a complete and/or partial eutectic melting process of outer wires of the strand which have been freed by concurrently compacting and/or predeforming an insulating layer,
b) segment 2: producing a diffusion bond and/or an at least partial fusion bond between inner wires of the strand which have been freed from the insulating layer by the compacting,
c) segment 3: currentless cooling of the hot-crimped connection,
wherein a switchover takes place between at least two successive segments after a segment-specific height position has been reached and/or energy/charge has been fed in.

18. The method according to claim 17,
wherein a respective segment is switched off if a time period defined depending on the segment is exceeded.

19. The method according to claim 17,
wherein an electrode current is regulated in such a way that a path-time trajectory of electrodes follows a sinking speed defined depending on the segment, and a switchover to a next segment takes place after dropping below a segment-specific height position and/or reaching an energy/charge.

20. The method according to claim 17,
wherein the first connection according to step a) in segment 1 takes place through a soldering process.

21. The method according to claim 17,
wherein the first connection according to step a) in segment 1 takes place through a eutectic melting process of uncoated components.

22. The method according to claim 17,
wherein the shaped part is coated with a metal which is identical or metallurgically very similar to a material of the strand.

23. The method according to claim 17,
wherein the steps a and/or b and/or c are subdivided into further segments.

24. The method according to claim 17,
wherein a pressing force, a current curve, a current level, a sinking speed, a maximum duration, an energy/charge, and a switchover height are defined for each segment.

25. The method according to claim 24,
wherein instead of the switchover height, an electrode travel path is defined as a switchover criterion.

26. The method according to claim 17,
wherein a heat expansion stroke and, for each individual segment, a duration and/or a travel path and/or a sinking speed and/or an energy/load are used as quality criteria.

27. The method according to claim 17,
wherein at least two opposing electrodes consist of different materials.

28. The method according to claim 17,
wherein contact surfaces of electrodes relative to the component are different in each case.

29. The method according to claim 17,
wherein a height-monitored predeforming takes place prior to the hot crimping.

30. The method according to claim 17,
wherein the predeforming and hot crimping are carried out simultaneously or in immediate succession in the same arrangement.

31. The method according to claim 17,
wherein the predeforming is carried out during heating within the segment 1.

32. The method according to claim 17,
wherein, all process-relevant setting variables and measured values are recorded and assigned to an individual component.
